(19) United States
(12) Patent Application Publication
(10) Pub. No.: US 2013/0074004 A1
(43) Pub. Date: Mar. 21, 2013

(54) METHOD AND DEVICE FOR DISPLAYING DIGEST OF RSS BY WINDOW

(71) Applicants: JACK LAU, WANCHAI (HK); KIN PING NG, WANCHAI (HK)

(72) Inventors: JACK LAU, WANCHAI (HK); KIN PING NG, WANCHAI (HK)

(73) Assignee: PERCEPTION DIGITAL LIMITED, WANCHAI (HK)

(21) Appl. No.: 13/343,119

(22) Filed: Jan. 4, 2012

(30) Foreign Application Priority Data
Sep. 21, 2011 (CN) 201110281933.9

(51) Int. Cl. G06F 3/048

(52) U.S. Cl. 715/784

(57) ABSTRACT

A method for displaying digest of RSS by window according to a preferred embodiment includes: obtaining digest information of RSS feed; and scrolling the digest information of RSS feed on a displaying region of a display device. In a preferred embodiment, the method for displaying digest of RSS by window further includes step of pausing scrolling of the digest information of RSS feed when a cursor enters the displaying region, and resuming scrolling of the digest information of RSS feed when the cursor leaves the displaying region.

### BACKGROUND

1. Technical Field

The present disclosure relates to computer technologies, and particularly, to a method and device for displaying digest of RSS by window.

2. Discussion of Related Art

RSS (Really Simple Syndication) is a simple tool for online sharing information in conventional technique. RSS sources usually send a strong timeliness content to the RSS subscribers via feed (a standard information export of RSS format). RSS feed includes digests of the strong timeliness content. When finishing reading the digests of the strong time-release source, if the subscribers want to read specific content corresponding to the digests, they may click a link corresponding to the digests to read the specific content.

The conventional subscription tool displays the digests of RSS feed in a list, and the digest of RSS feed of the most recently received RSS feeds is always placed on the top of the list. If there are excessive number of the digests of RSS feed, the digests of RSS feed will be displayed in the form of different pages or scroll bar. The subscribers have to click or slide the mouse to read the digests of RSS feed. When the titles of the digests of RSS feed are too long and exceed area of a display window, the subscribers need to click the control button repeatedly to view the titles. Therefore, the above mentioned method for displaying digest of RSS feed is very inconvenient to view the digests of RSS feed.

Therefore, a device and method for displaying digest of RSS by window are desired in order to overcome the above-described shortcomings.

### SUMMARY OF THE INVENTION

In one aspect, a method for displaying digest of RSS by window according to a preferred embodiment includes: obtaining digest information of RSS feed; and scrolling the digest information of RSS feed on a displaying region of a display device.

In a preferred embodiment, the method for displaying digest of RSS by window after step of scrolling the digest information of RSS feed on a displaying region of a display device, further comprising: pausing scrolling of the digest information of RSS feed when a cursor enters the displaying region, and resuming scrolling of the digest information of RSS feed when the cursor leaves the displaying region.

In a preferred embodiment, the method for displaying digest of RSS by window after step of scrolling the digest information of RSS feed on a displaying region of a display device, further comprising: obtaining a displacement from a position of a cursor to a reference position of the displaying region after the cursor enters the displaying region, and adjusting scrolling speed of the digest information of RSS feed based on the displacement.

In a preferred embodiment, wherein a visualization of the digest information of RSS feed is at least one of link, icon and button.

In a preferred embodiment, the method for displaying digest of RSS by window after step of scrolling the digest information of RSS feed on a displaying region of a display device, further comprising: popping up a display window containing a specific content corresponding to the digest after obtaining a press event of the digest information of RSS feed, and automatically filling a stored form data in the display window.

In other aspect, a device for displaying digest of RSS by window according to a preferred embodiment includes:
a display device capable of providing a displaying region;
a processor capable of obtaining digest information of RSS feed and sending the digest information of RSS feed to the display device, wherein the display device displays the digest information of RSS feed on the displaying region in a scrollable way.

In a preferred embodiment, the device for displaying digest of RSS by window further comprising:
a first input device connected to the processor and configured to obtain a position of a cursor in the displaying region and send the position of the cursor to the processor;
wherein the processor is further configured to send an instruction of pausing scrolling when the processor detects the cursor entering the displaying region, and send an instruction of resuming scrolling when the processor detects the cursor leaving the displaying region; and the display device performs the corresponding operations when the display device receives the instructions of pausing scrolling or resuming scrolling.

In a preferred embodiment, the device for displaying digest of RSS by window further comprising:
a second input device connected to the processor and configured to obtain a displacement from the position of the cursor in the displaying region to a reference position of the displaying region and send the displacement to the processor;
wherein the processor adjusts the scrolling speed based on the displacement, and sends the adjusted scrolling speed to the display device, the display device displays the digest information of RSS feed at the adjusted scrolling speed in a scrollable way.

In a preferred embodiment, wherein a visualization of the digest information of RSS feed is at least one of link, icon and button.

In a preferred embodiment, the device for displaying digest of RSS by window further comprising:
a storage device connected to the processor and storing form data; and
a third input device connected to the processor and configured to obtain press events of the digest information of RSS feed and send the press events to the processor;
wherein the processor sends form data to the display device after receiving the press events, and the display device pops up a display window after receiving the form data and fills the form data in the display window.

In other aspect, a method for displaying digest of RSS by window according to another preferred embodiment includes:
step a, obtaining digest information of RSS feed;
step b, scrolling the digest information of RSS feed on a displaying region of a display device;
step c, activating visualization of the digest information of RSS feed; and
step d, popping up a display window containing specific content corresponding to the digest information of RSS feed.

In a preferred embodiment, the method for displaying digest of RSS by window further comprising step e between step b and step c:
step e, pausing scrolling of the digest information of RSS feed when a cursor enters the displaying region, and resuming scrolling of the digest information of RSS feed when the cursor leaves the displaying region.

In a preferred embodiment, the method for displaying digest of RSS by window further comprising step f between step b and step c:
step f, obtaining a displacement from a position of a cursor to a reference position of the displaying region after the cursor enters the displaying region, and adjusting scrolling speed of the digest information of RSS feed based on the displacement.

In a preferred embodiment, wherein the scrolling speed is predetermined to be proportional to the value of the displacement.

In a preferred embodiment, wherein the displaying region is substantially rectangular, and the reference position is a center line located in the middle of the displaying region; wherein the digest information of RSS feed is scrolled from the left to the right when a cursor is located in the right side of the center line, and the digest information of RSS feed is scrolled from the right to the left when the cursor is located in the left side of the center line.

In a preferred embodiment, wherein the digest information of RSS feed is paused scrolling when the cursor is located in the center of the displaying region, and the digest information of RSS feed is resumed scrolling at an initial speed when the cursor leaves the displaying region.

In a preferred embodiment, wherein the visualization of the digest information of RSS feed is at least one of link, icon and button.

In a preferred embodiment, the method for displaying digest of RSS by window further comprising step g after step d:
step g, automatically filling a stored form data in an input region of the display window.

In a preferred embodiment, wherein the visualization of the digest information of RSS feed is at least one of activated by mouse click events, touching screen events or pressing on a button of keyboard.

In a preferred embodiment, wherein the digest information of RSS feed is scrolled at a certain speed.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is a flow chart of an embodiment of a method for displaying digest of RSS by window.

FIG. 2 is a schematic view of a display device using in the method for displaying digest of RSS by window shown in FIG. 1.

FIG. 3 is a schematic view of one embodiment of a device for displaying digest of RSS by window.

### DETAILED DESCRIPTION OF THE PREFERRED EMBODIMENTS

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

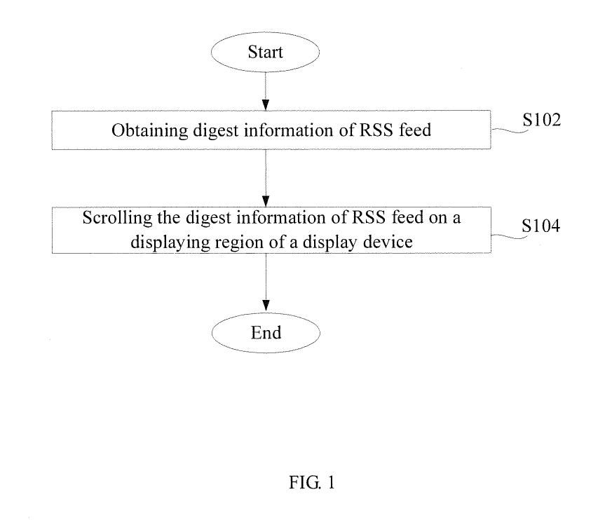

Referring to FIG. 1, an embodiment of a method for displaying digest of RSS by window includes following steps:

Step 102, digest information of RSS feed is obtained.

In one embodiment, a channel subscriber subscribes one channel to obtain information of the channel via the RSS feed, and the information of the channel may be news, questionnaire, orders and so on. The RSS feed are regularly updated based on links in the feed information. The feed information includes a digest of the latest information and an address (may be referenced as “link”) of the available information. A plurality of digests of RSS feed constitute a digest sequence, the digest sequence are usually arranged in chronological order by the release time.

Step S104, the digest information of RSS feed are scrolled in a displaying region of a display device.

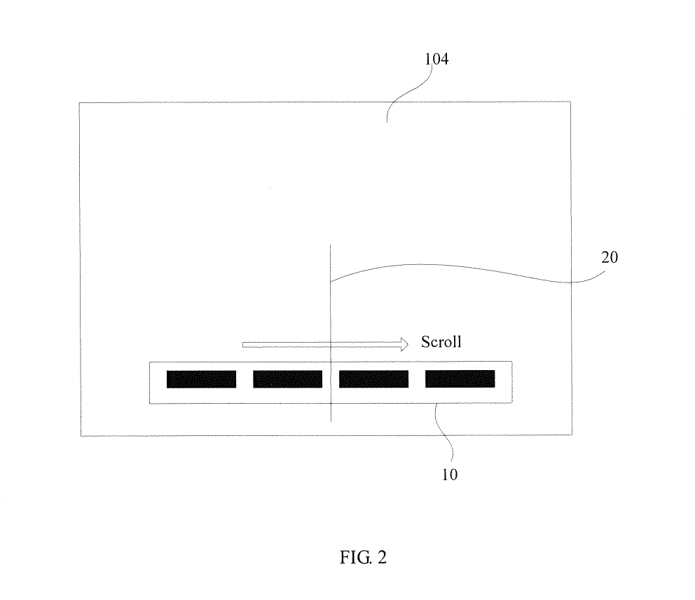

In a preferable embodiment, the display device is a monitor. In other embodiment, the display device may be a projector, or a 3D imaging device. Referring to FIG. 2, a displaying region 10, which is substantially rectangular, is defined on the bottom of the screen of the display device. In a preferable embodiment, the digest information of RSS feed is displayed on the displaying region 10 by icon model. In other embodiment, the digest information of RSS feed is displayed on the displaying region 10 by link model or button model. Text of an icon corresponds to the text of the digest information of RSS feed, and the activation event of the icon corresponds the link in the digest information of RSS feed. The activation events of the icon include mouse click events, press events such as touching screen, and pressing on a button of keyboard and so on.

In the present embodiment, the icon displayed in the displaying region is scrolled at a certain speed, and it is preferably scrolled from left to right at a uniform speed. The digest information of RSS feeds are always arranged in chronological order by the release time, and the digest information released earlier is away located at right of the digest information released later.

In another embodiment, after step of displaying the digest information of RSS feed on the displaying region of the display device, the method for displaying digest of RSS by window further includes:

The icon is paused scrolling when the cursor enters the displaying region, and the icon is resumed scrolling when the cursor leaves the displaying region.

When the icon is scrolled too fast, the subscriber will take some time to read the text of the icon, therefore, the icon may not be activated because the subscriber needs much more time to read the text of the icon. The icon is activated means that clicking mouse, touching screen, or pressing on a button of keyboard. When the icon is paused scrolling, the subscriber will have sufficient time to read the text of the icon. Therefore, the above mentioned step is convenient for activating the icon.

In another embodiment, after step of displaying the digest information of RSS feed on the displaying region of the display device, the method for displaying digest of RSS by window further includes:

When the cursor enters the displaying region, a displacement from the position of the cursor to a reference position of the displaying region is obtained, and the scrolling speed of the digest information of RSS feed is adjusted based on the displacement. The reference position of the displaying region may be any of selected positions to be a reference of calculation of the displacement.

Referring to FIG. 2, the displaying region 10 is preferably substantially rectangular, the reference position is preferably a center line 20 located in the middle of the displaying region 10. It should be pointed that the display region 10 is not only be limited to rectangular-shaped, but also the other shape such as round-shaped, oval shaped and so on. The icon located in the displaying region 10 is scrolled from the left to the right at an initial speed. The position of the cursor is obtained, and then the displacement from the position of the cursor to the center line 20 is calculated. In a preferable embodiment, the scrolling speed is predetermined to be proportional to the value of the displacement. In other words, the position of the cursor is farther away from the center line 20, the scrolling speed is higher; the position of the cursor is closer from the center line 20, the scrolling speed is lower. When the cursor is located in the center of the displaying region 10, the icon is paused scrolling. When the cursor leaves the displaying region 10, the icon is resumed scrolling at the initial speed.

It should be pointed that, the displacement is a vector. In other words, when the cursor is located at opposite sides of the center line 20 respectively, the distances from the position to the center line 20 are the same, but the directions of the displacement are different. When the cursor is located in the right side of the center line 20, the icon is scrolled from the left to the right; when the cursor is located in the left side of the center line 20, the icon is scrolled from the right to the left.

The scrolling speed of the cursor corresponds to the displacement from the position to the reference position, such that the icon is positioned conveniently when the subscriber reads the displayed digest of the RSS feed. When one digest information of RSS feed is too long, the icon displaying the digest information of RSS feed is too large and exceeds the area of the displaying region. The user can move the cursor, such that the icon is slid in the displaying region, and then the user may see the complete digest information of RSS feed.

In another embodiment, after step of displaying the digest information of RSS feed on the displaying region of the display device, the method for displaying digest of RSS by window further includes:

A display window is popped up after obtaining press events of the digest of RSS feed, and a stored form data is automatically filled in the display window. The display window includes the specific content corresponding to the digest of RSS feed.

For example, when the digest of RSS feed is an order, such as some of buy information and online shopping information and so on, a display window will pop up when the icon is activated by a subscriber. The display window is preferably a web page, some stored information will be automatically filled in an input region of the web page. For example, when a subscriber opens a web page including online shopping information, the web page contains an input region in which the subscriber write some shopping related information, such as name, the consignee address, telephone and other contact information of the subscriber. The shopping related information will not be altered, and automatically filled in the input region of the web page.

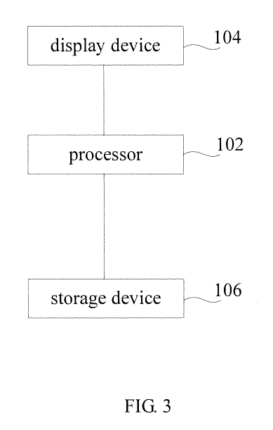

Referring to FIG. 3, an embodiment of a device for displaying digest of RSS by window of one embodiment includes a processor 102 and a display device 104. The processor 102 is capable of obtaining digest information of RSS feed and sending the digest information of RSS feed to the display device 104. The display device 104 is capable of displaying the digest information of RSS feed on a displaying region in a scrollable way.

In the present embodiment, a subscriber subscribes one channel to obtain information of the channel via the RSS feed, the information of the channel may be news, questionnaire, orders and so on.

The RSS feed are regularly updated based on links in the feed information. The feed information includes a digest of the latest information and an address (may be referenced as “link”) of the available information. A plurality of digests of RSS feed constitute a digest sequence, the digest sequence are usually arranged in chronological order by the release time.

In a preferable embodiment, the display device is a monitor. In other embodiment, the display device may be a projector, or a 3D imaging device.

Referring to FIG. 2, a displaying region 10 is substantially rectangular, and is defined on the bottom of the screen of the display device. It should be pointed that the display region is not only be limited to rectangular-shaped, but also the other shape such as round-shaped, oval shaped and so on. In a preferable embodiment, the digest information of RSS feed is displayed on the displaying region 10 by icon model. In other embodiment, the digest information of RSS feed is displayed on the displaying region 10 by link model or button model. Text of an icon corresponds to the text of the digest information of RSS feed, and the activation event of the icon corresponds the link in the digest information of RSS feed. The activation events of the icon include mouse click events, press events such as touching screen, and pressing on a button of keyboard and so on.

In the present embodiment, the icon displayed in the displaying region is scrolled at a certain speed, and it is preferably scrolled from left to right at a uniform speed. The digest information of RSS feed are always arranged in chronological order by the release time, and the digest information released earlier is away located at right of the digest information released later.

In another embodiment, the device for displaying digest of RSS by window further includes a first input device (not shown) connected to the processor 102. The first input device is configured to obtain the position of the cursor in the displaying region of the display device, and send the position of the cursor to the processor 102. The processor 102 sends an instruction of pausing scrolling when the processor 102 detects the cursor entering the displaying region of the display device 104, and sends an instruction of resuming scrolling when the processor 102 detects the cursor leaving the displaying region of the display device 104. The display device 104 performs the corresponding operations when the display device 104 receives the instructions of pausing scrolling or resuming scrolling.

When the icon is scrolling too fast, the subscriber will take some time to read the text of the icon, therefore, the icon may not be activated because the subscriber has much more time to read the text of the icon. The icon is activated means that clicking mouse, touching screen, or pressing on a button of keyboard. When the icon is paused scrolling, the subscriber will have sufficient time to read the text of the icon. Therefore, the above mentioned step is convenient for activating the icon.

In another embodiment, the device for displaying digest of RSS by window not only includes the processor 102 and the display device 104, but also includes a second input device (not shown) connected to the processor 102. The second input device is configured to obtain a displacement from the position of the cursor in the displaying region of the display device 104 to a reference position of the displaying region, and send the displacement to the processor 102. The processor 102 adjusts the scrolling speed based on the displacement, and sends the adjusted scrolling speed to the display device 104. Then, the display device 104 displays the digest information of RSS feed at the adjusted scrolling speed in a scrollable way. The reference position of the displaying region may be any of selected positions to be a reference of calculation of the displacement.

Referring to FIG. 2, the displaying region 10 is preferably substantially rectangular, the reference position is preferably a center line 20 located in the middle of the displaying region 10. The icon located in the displaying region 10 is scrolled from the left to the right at an initial speed. The position of the cursor is obtained, and then the displacement from the position of the cursor to the center line 20 is calculated. In a preferable embodiment, the scrolling speed is predetermined to be proportional to the value of the displacement. In other words, the position of the cursor is farther away from the center line 20, the scrolling speed is higher; the position of the cursor is closer from the center line 20, the scrolling speed is lower. When the cursor is located in the center of the displaying region 10, the icon is paused scrolling. When the cursor is quit the displaying region 10, the icon is resumed scrolling at the initial speed.

It should be pointed that, the displacement is a vector. In other words, when the cursor is located at opposite sides of the center line 20 respectively, the distances from the position to the center line 20 are the same, but the directions of the displacement are different. When the cursor is located in the right side of the center line 20, the icon is scrolled from the left to the right; when the cursor is located in the left side of the center line 20, the icon is scrolled from the right to the left.

The scrolling speed of the cursor corresponds to the displacement from the position to the reference position, such that the icon is positioned conveniently when the subscriber reads the displayed digest information of RSS feed. When one digest information of RSS feed is too long, the icon displaying the digest information of RSS feed is too large and exceeds the area of the displaying region. The user can move the cursor, such that the icon is slid in the displaying region, and then the user may see the complete digest information of RSS feed.

In another embodiment, the device for displaying digest of RSS by window not only includes the processor 102 and the display device 104, but also includes a storage device 106 and a third input device (not shown). The storage device 106 and the third input device are connected to the processor 102. The storage device stores form data. The third input device is configured to obtain press events of the digest information of RSS feed, and send the press events to the processor 102. The processor 102 send form data to the display device 104 after receiving the press events. The display device pops up a display window after receiving the form data, and fills the form data in the display window.

For example, when the digest of RSS feed is an order, such as some of buy information and online shopping information and so on, a display window will pop up when the icon is activated by a subscriber. The display window is preferably a web page, some stored information will be automatically filled in a input region of the web page. For example, when a subscriber opens a web page including online shopping information, the web page contains an input region in which the subscriber write some shopping related information, such as name, the consignee address, telephone and other contact information of the subscriber. The some shopping related information will not be altered, and automatically filled in a corresponding input region of the web page.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. A method for displaying digest of RSS by window, comprising:
obtaining digest information of RSS feed; and
scrolling the digest information of RSS feed on a displaying region of a display device.

2. The method for displaying digest of RSS by window of claim 1, after step of scrolling the digest information of RSS feed on a displaying region of a display device, further comprising:
pausing scrolling of the digest information of RSS feed when a cursor enters the displaying region, and resuming scrolling of the digest information of RSS feed when the cursor leaves the displaying region.

3. The method for displaying digest of RSS by window of claim 1, after step of scrolling the digest information of RSS feed on a displaying region of a display device, further comprising:
obtaining a displacement from a position of a cursor to a reference position of the displaying region after the cursor enters the displaying region, and adjusting scrolling speed of the digest information of RSS feed based on the displacement.

4. The method for displaying digest of RSS by window of claim 1, wherein a visualization of the digest information of RSS feed is at least one of link, icon and button.

5. The method for displaying digest of RSS by window of claim 1, after step of scrolling the digest information of RSS feed on a displaying region of a display device, further comprising:
popping up a display window containing a specific content corresponding to the digest after obtaining a press event of the digest information of RSS feed, and automatically filling a stored form data in the display window.

6. A device for displaying digest of RSS by window, comprising:
a display device capable of providing a displaying region;
a processor capable of obtaining digest information of RSS feed and sending the digest information of RSS feed to the display device, wherein the display device displays the digest information of RSS feed on the displaying region in a scrollable way.

7. The device for displaying digest of RSS by window of claim 6, further comprising:
a first input device connected to the processor and configured to obtain a position of a cursor in the displaying region and send the position of the cursor to the processor;
wherein the processor is further configured to send an instruction of pausing scrolling when the processor detects the cursor entering the displaying region, and send an instruction of resuming scrolling when the processor detects the cursor leaving the displaying region; and the display device performs the corresponding operations when the display device receives the instructions of pausing scrolling or resuming scrolling.

8. The device for displaying digest of RSS by window of claim 6, further comprising:
a second input device connected to the processor and configured to obtain a displacement from the position of the cursor in the displaying region to a reference position of the displaying region and send the displacement to the processor;
wherein the processor adjusts the scrolling speed based on the displacement, and sends the adjusted scrolling speed to the display device, the display device displays the digest information of RSS feed at the adjusted scrolling speed in a scrollable way.

9. The device for displaying digest of RSS by window of claim 6, wherein a visualization of the digest information of RSS feed is at least one of link, icon and button.

10. The device for displaying digest of RSS by window claim 6, further comprising:
a storage device connected to the processor and storing form data; and
a third input device connected to the processor and configured to obtain press events of the digest information of RSS feed and send the press events to the processor;
wherein the processor sends form data to the display device after receiving the press events, and the display device pops up a display window after receiving the form data and fills the form data in the display window.

11. A method for displaying digest of RSS by window, comprising:
step a, obtaining digest information of RSS feed;
step b, scrolling the digest information of RSS feed on a displaying region of a display device;
step c, activating visualization of the digest information of RSS feed; and
step d, popping up a display window containing specific content corresponding to the digest information of RSS feed.

12. The method for displaying digest of RSS by window of claim 11, further comprising step e between step b and step c:
step e, pausing scrolling of the digest information of RSS feed when a cursor enters the displaying region, and resuming scrolling of the digest information of RSS feed when the cursor leaves the displaying region.

13. The method for displaying digest of RSS by window of claim 11, further comprising step f between step b and step c:
step f, obtaining a displacement from a position of a cursor to a reference position of the displaying region after the cursor enters the displaying region, and adjusting scrolling speed of the digest information of RSS feed based on the displacement.

14. The method for displaying digest of RSS by window of claim 13, wherein the scrolling speed is predetermined to be proportional to the value of the displacement.

15. The method for displaying digest of RSS by window of claim 13, wherein the displaying region is substantially rectangular, and the reference position is a center line located in the middle of the displaying region; wherein the digest information of RSS feed is scrolled from the left to the right when a cursor is located in the right side of the center line, and the digest information of RSS feed is scrolled from the right to the left when the cursor is located in the left side of the center line.

16. The method for displaying digest of RSS by window of claim 15, wherein the digest information of RSS feed is paused scrolling when the cursor is located in the center of the displaying region, and the digest information of RSS feed is resumed scrolling at an initial speed when the cursor leaves the displaying region.

17. The method for displaying digest of RSS by window of claim 11, wherein the visualization of the digest information of RSS feed is at least one of link, icon and button.

18. The method for displaying digest of RSS by window of claim 11, after step d, further comprising step g :
step g, automatically filling a stored form data in an input region of the display window.

19. The method for displaying digest of RSS by window of claim 11, wherein the visualization of the digest information of RSS feed is at least one of activated by mouse click events, touching screen events or pressing on a button of keyboard.

20. The method for displaying digest of RSS by window of claim 19, wherein the digest information of RSS feed is scrolled at a certain speed.
